(19) United States
(12) Patent Application Publication
(10) Pub. No.: US 2006/0257645 A1
(43) Pub. Date: Nov. 16, 2006

(54) Electrically conductive film, actuator element and method for producing the same

(75) Inventors: Kinji Asaka, Ikeda-shi (JP); Takushi Sugino, Ikeda-shi (JP); Ichirou Takeuchi, Ikeda-shi (JP); Kenji Hata, Tsukuba-shi (JP)

Correspondence Address: POSZ LAW GROUP, PLC, 12040 SOUTH LAKES DRIVE, SUITE 101, RESTON, VA, 20191, US

(73) Assignee: NATIONAL INSTITUTE OF ADVANCED INDUSTRIAL SCIENCE AND TECHNOLOGY, Tokyo-to (JP)

(21) Appl. No.: 11/392,960

(22) Filed: Mar. 30, 2006

(30) Foreign Application Priority Data
Mar. 31, 2005 (JP) 2005-103182
Oct. 7, 2005 (JP) 2005-294254
Mar. 6, 2006 (JP) 2006-058809

(51) Int. Cl. B32B 5/16; C08K 3/04

(52) U.S. Cl. 428/323; 524/495

(57) ABSTRACT

The present invention provides a method for easily producing an excellent actuator element wherein carbon nanotubes are extremely well dispersed, in the production of an actuator element using a hydrophilic ionic liquid.

According to one embodiment, the invention provides an electroconductive film composed of a polymer gel having carbon nanotubes with an aspect ratio of at least 10³ or more, an ionic liquid, and a polymer.

### TECHNICAL FIELD

The present invention relates to an electroconductive film, a laminate comprising the electroconductive film, an actuator element, and a method for producing the actuator element. The actuator element is an actuator element wherein the driving force is an electrochemical process, such as electrochemical reaction or charging and discharging of an electric double layer.

### BACKGROUND OF THE INVENTION

In recent years, with the advent of the aging society and fewer children, there is an increasing need, in the fields of ubiquitous home electric appliances and health appliances (that anyone can use safely and easily, anywhere at anytime, such as medical appliances and nursing robots), for a polymer actuator that is light in weight and that can be downsized, and further is safe and highly flexible, in place of conventional moters and pumps made of inorganic materials such as metals and ceramics. Actuators using various polymer materials have been developed for this purpose. In terms of safety for use close to human bodies or humans' living environments, the following are representative examples of available actuators that operate with excellent responsiveness at a low voltage: electron conductive polymer actuators comprising electroconductive polymers such as polypyrrole and polyaniline, and ionic conductive polymer actuators comprising ion exchange membranes and plating electrodes. These two types of actuators are both generally used in electrolyte solutions because an electrolyte is needed for their operation. Ionic conductive polymer actuators are basically used in water, because they do not exhibit sufficient ionic conductivity unless their ion exchange resin is in a water-swelled state. In order to use such an actuator in air, it is necessary to prevent water evaporation. Although a method of resin coating has been reported in this connection, such a method has not been put into practical use because, using this method, it is difficult to achieve a complete coating. This is also because the resulting coating breaks with even a small amount of gas generation due to electrode reaction, and further, the coating itself causes resistance in displacement response. Although propylene carbonate or a like high-boiling-point organic solvent is sometimes used instead of water, this also leads to similar problems as those above, and is moreover problematic in that, because their ionic electrical conductivity is lower than that of water, the resulting responsiveness is inferior. There is also a durability problem resulting from oxidation-reduction reaction at the electrode surface.

Accordingly, the use of conventional actuators is extremely limited, because the environment in which they are driven is limited to electrolyte solutions. The development of an actuator element that operates in air is thus indispensable for finding wider practical application of a miniaturized actuator.

In order to solve the above problems, an actuator element has been suggested which comprises, as an electroconductive flexible active layer, a gel of carbon nanotubes and an ionic liquid, and is thereby capable of operating in air or a vacuum (see FUKUSHIMA, Takanori, et al., Dry Actuators Composed of Carbon Nanotube-Ionic Liquid Gels, Polymer Preprints Japan, 2004, Vol. 53, 2, pp. 4816-4817).

Such an actuator can be produced by dispersing a [gel-like composition comprising carbon nanotubes, an ionic liquid, and a polymer] in a solvent and a [gel-like composition comprising an ionic liquid and a polymer] in another solvent, and laminating the dispersion liquids by casting, coating, printing, extrusion, and/or ejection.

With conventional methods, however, it is difficult to uniformly mix carbon nanotubes, a polymer and an ionic liquid, thereby causing degradation in actuator performance.

### DISCLOSURE OF THE INVENTION

An object of the present invention is to provide an electroconductive film and a laminate useful in an actuator, and also provide an actuator element and a method for producing the same.

Another object of the present invention is to provide an actuator having higher responsiveness, by processing a carbon material that is an electric conductor and thereby controlling its surface area, strength, and structure.

Given this background, the present inventors have developed, as an actuator that operates in air and can be repeatedly used at low voltages, an actuator wherein carbon nanotubes and an ionic liquid are employed as electrode materials. Such an actuator ensures a rapid response at low voltages, and, because electrode reaction does not follow, is highly resistant to repetitive use. Furthermore, it can be expected that stress in the high GPa range will be generated due to mechanical characteristics of the carbon nanotubes (sometimes referred to as CNTs hereinafter). The present invention provides the following electroconductive films, laminates comprising the electroconductive films, actuator elements, and methods for producing the actuator elements.
1. An electroconductive film comprising a polymer gel containing carbon nanotubes with an aspect ratio of at least 10³, an ionic liquid, and a polymer.
2. An electroconductive film comprising a polymer gel containing carbon nanotubes with a length of at least 50 μm, an ionic liquid, and a polymer.
3. An electroconductive film characterized in that the electroconductive film comprises a polymer gel containing carbon nanotubes, an ionic liquid, and a polymer, and that the carbon nanotubes and the polymer form complexes having a mean width of 50 nm or less.
4. A laminate comprising:

a layer of an electroconductive film of any one of items 1 to 3, and

an ionic conductive layer.
5. An actuator element comprising a laminate of item 4.
6. An actuator element according to item 5, wherein at least two electroconductive film layers are formed as electrodes on an ion conductive layer in a mutually insulated state, said at least two electroconductive film layers each consisting of an electroconductive film of any one of items 1 to 3, the actuator element being deformable by application of a potential difference between the electrocdnductive film layers.
7. A method for producing an actuator element, comprising the steps of:
step 1: preparing a dispersion liquid containing carbon nanotubes, an ionic liquid, a polymer, and a solvent;
step 2: preparing a solution containing a polymer, a solvent, and optionally an ionic liquid; and
step 3: forming a laminate comprising an electroconductive film layer and an ion-conductive layer, by forming an electroconductive film layer from the dispersion liquid of step 1 and simultaneously or subsequently forming an ion-conductive layer from the solution of step 2 (the electroconductive film layer and the ion-conductive layer each being formed by coating, printing, extrusion, casting, or ejection), wherein each said solvent is a mixed solvent of a hydrophilic solvent and a hydrophobic solvent.
8. A method according to item 7, wherein the carbon nanotubes are carbon nanotubes with an aspect ratio of at least 10³.

The present invention provides an actuator element that bends and deforms to a greater degree than conventional products upon application of voltage. The present invention enables the development of an actuator for operation in air, which moves flexibly and greatly at lowered voltages. Further, an electroconductive film comprising carbon nanotubes and an ionic liquid can also be utilized as an excellent capacitor in the field of cells.

When long carbon nanotubes with a high aspect ratio are employed, the thereby obtained actuator element is especially excellent.

### BEST MODE FOR CARRYING OUT THE INVENTION

The present invention is explained in detail hereafter.

Ionic liquids used in the invention are salts that are in the molten state over a wide range of temperatures, including an ordinary temperature (room temperature), and are sometimes referred to as room-temperature molten salts or simply as molten salts. An example thereof is a salt that is in the molten state at a temperature of 0° C., preferably −20° C., and more preferably −40° C. The ionic liquid used in the present invention preferably has high ionic conductivity.

Any of various known ionic liquids may be used in the present invention. Preferable are stable ionic liquids that are in the liquid state at an ordinary temperature (room temperature) or thereabouts. Examples of ionic liquids suitable for use in the present invention include those with an anion (X⁻) and a cation represented by the following general formulae (I) to (IV) (preferably imidazolium ions, quaternary ammonium ions):

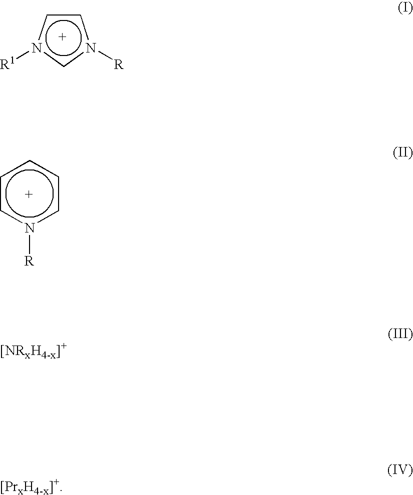

In the above formulae (I)-(IV), R is a straight or branched C₁₋₁₂ alkyl group, or instead is a straight or branched alkyl group containing an ether bond and wherein the total number of carbon and oxygen atoms is 3 to 12. In formula (I), R¹ is a straight or branched C₁₋₄ alkyl group or a hydrogen atom. R and R¹ in formula (I) are preferably not the same. In formulae (III) and (IV), each x is an integer from 1 to 4.

Examples of straight and branched C₁₋₁₂ alkyl groups include methyl, ethyl, n-propyl, isopropyl, n-butyl, isobutyl, sec-butyl, t-butyl, pentyl, hexyl, heptyl, octyl, nonyl, decyl, undecyl, and dodecyl. The number of carbons therein is preferably 1 to 8, and more preferably 1 to 6.

Examples of C₁₋₄ straight and branched alkyl groups include methyl, ethyl, n-propyl, isopropyl, n-butyl, isobutyl, sec-butyl, and t-butyl.

Examples of straight and branched alkyl groups containing an ether bond and wherein the total number of carbon and oxygen atoms is 3 to 12 include CH₂OCH₃, and (CH₂)ₚ(OCH₂CH₂)_{q}OR₂ (wherein p is an integer from 1 to 4, q is an integer from 1 to 4, and R₂ is CH₃ or C₂H₅).

Examples of anions (X⁻) include tetrafluoroborate ions (BF₄⁻), BF₃CF₃⁻, BF₃C₂F₅⁻, BF₃C₃F₇⁻, BF₃C₄F₉⁻, hexafluorophosphate ions (PF₆⁻), bis(trifluoromethanesulfonyl)imide ions ((CF₃SO₂)₂N⁻), perchlorate ions (ClO₄⁻), tris(trifluoromethanesulfonyl)carbide ions ((CF₃SO₂) ₃C⁻), trifluoromethansulfonate ions (CF₃SO₃⁻), dicyanamide ions ((CN)₂N⁻), trifluoroacetate ions (CF₃COO⁻), organic carboxylate ions, and halogen ions.

A specific example of an ionic liquid is one wherein the cation is a 1-ethyl-3-methylimidazolium ion or [N (CH₃) (CH₃) (C₂H₅) (C₂H₄OC₂H₄0CH₃)]⁺ and the anion is a halogen ion or a tetrafluoroborate ion. Two or more kinds of cations and/or anions may be used to thereby further lower the melting point.

Usable ionic liquids are not limited to such combinations, and include any ionic liquids having an electrical conductivity of at least 0.1 Sm⁻¹.

Carbon nanotubes used in the present invention are carbon-based materials wherein a graphene sheet is rolled into a cylindrical shape. Various carbon nanotubes are known, and they are broadly divided according to their wall number into two categories: single-walled carbon nanotubes (SWNTs) and multi-walled carbon nanobutes (MWNTs). They can also be classified based on the graphene sheet structure into chiral type, zigzag type, and armchair type. Any kind of carbon nanotubes can be used in the present invention, as long as they are what are generally called carbon nanotubes. In general, single-walled nanotubes with a high aspect ratio, which, in other words, are thin and long, give easy gelation. Examples thereof include carbon nanotubes with an aspect ratio of 10³ or more, and preferably 10⁴ or more. The carbon nanotube length is usually 1 μm or more, preferably 50 μm or more, and more preferably 500 μm or more. Although not limited thereto, the upper limit of may be, for example, about 30 mm.

Accordingly, in the present invention, it is preferable to obtain a gel-like composition from SWNTs. Although not limited thereto, one example of preferable carbon nanotubes for practical use is HiPco (a product of Carbon Nanotechnologies Inc.) that is, using carbon monoxide as the starting material, can be produced in relatively large batches.

Examples of polymers used in the present invention include copolymers of fluoroolefins having hydrogen atoms and perfluoroolefins, such as polyvinylidene fluoride-hexafluoropropylene copolymers [PVDF (HFP)]; homopolymers of fluoroolefins having hydrogen atoms, such as polyvinylidene fluoride (PVDF); perfluorosulfonic acid (Nafion); poly(meth)acrylates such as poly-2-hydroxyethyl methacrylate (poly-HEMA) and polymethyl methacylate (PMMA); polyethylene oxide (PEO); and polyacrylonitrile (PAN).

It is important in the present invention that, in the preparation of an electrical conductive film layer comprising carbon nanotubes, an ionic liquid and optionally a polymer, the ingredients are mixed uniformly. For the preparation of a dispersion liquid wherein ingredients are uniformly mixed, it is preferable to use a solvent. A mixed solvent of a hydrophobic solvent and a hydrophilic solvent is especially preferable.

Examples of hydrophilic solvents include carbonates such as ethylene carbonate, propylene carbonate, dimethyl carbonate, diethyl carbonate, methyl ethyl carbonate, propylene carbonate, and butylene carbonate; ethers such as tetrahydrofuran; acetone; C₁₋₃ lower alcohols such as methanol and ethanol; and acetonitrile. Examples of hydrophobic solvents include C₅₋₁₀ ketones such as 4-methylpentan-2-one; halogenated hydrocarbons such as chloroform and methylene chloride; aromatic hydrocarbons such as toluene, benzene, and xylene; and aliphatic and cycloaliphatic hydrocarbons such as hexane and cyclohexane.

A dispersion liquid for producing the electroconductive film of the present invention may be prepared by kneading and thereby gelating an ionic liquid and carbon nanotubes, and then adding thereto a polymer and a solvent (such a solvent may be, for example, a mixed solvent of hydrophilic and hydrophobic solvents when the ionic liquid is hydrophilic, or a hydrophobic solvent when the ionic liquid is hydrophobic). A dispersion liquid may also be prepared without a gelation process, by simply mixing carbon nanotubes, an ionic liquid, a polymer, and optionally a solvent (such a solvent may be, for example, a mixed solvent of hydrophilic and hydrophobic solvents when the ionic liquid is hydrophilic, or a hydrophobic solvent when the ionic liquid is hydrophobic).

When a dispersion liquid is prepared with gelation, the ratio (weight ratio) of hydrophilic solvent:hydrophobic solvent in a mixed solvent is preferably 20:1 to 1:10, and more preferably 2:1 to 1:5.

When a dispersion liquid is prapared without a gelation process, hydrophilic solvent(PC)/hydrophobic solvent(MP) is preferably 1/100 to 20/100, and more preferably 3/100 to 15/100.

Each electroconductive film layer comprises a polymer gel containing carbon nanotubes, an ionic liquid, and a polymer.

The proportions of these ingredients in the electroconductive film layer are:
carbon nanotubes: 1 to 40 wt %, and preferably 5 to 20 wt %;
ionic liquid: 20 to 80 wt %, and preferably 35 to 70 wt %; and
polymer: 5 to 70 wt %, and preferably 20 to 60 wt %.

The ratio (weight ratio) of (carbon nanotubes+ionic liquid) to (polymer) in the electroconductive film layer is preferably 1:2 to 4:1, and more preferably 1:1 to 2:1. When such a composition is employed, a mixed solvent of a hydrophilic solvent and a hydrophobic solvent is to be used. It is also possible to obtain a dispersion liquid for electroconductive film preparation by mixing carbon nanotubes and an ionic liquid to thereby form a gel, and then mixing a polymer and a solvent (preferably a hydrophobic solvent) into the gel. In this case, the (carbon nanotubes+ionic liquid):(polymer) ratio is preferably 1:1 to 3:1.

The electroconductive film layer may contain some amount of solvent (hydrophobic solvent and/or hydrophilic solvent), although it is preferable that any removable solvent be removed as much as possible under ordinary drying conditions.

The gel-like composition of the ion-conductive layer comprises a polymer and an ionic liquid. A preferable ion-conductive layer is such that the ratio (weight ratio) of hydrophilic ionic liquid to polymer for the preparation of the gel-like composition is hydrophilic ionic liquid:polymer=1:4 to 4:1, and more preferably 1:2 to 2:1. When such a composition is employed, as above, a solvent wherein a hydrophilic solvent and a hydrophobic solvent are mixed in any ratio is preferably used.

The ion-conductive layer, which functions as a separator for separating two or more electroconductive film layers, can be obtained by dissolving a polymer in a solvent, and processing the same by a conventional technique such as coating, printing, extrusion, casting, or ejection. The ion-conductive layer may be formed essentially of only polymer, or it may instead be formed of a polymer and an ionic liquid added thereto.

The polymers used for the electroconductive film layer and the ion-conductive layer may the same or different. In order to improve the adhesion between the electroconductive film layer and the ion-conductive layer, the polymers are preferably the same or have similar properties.

A uniform dispersion liquid for electroconductive film layer preparation may be prepared by mixing carbon nanotubes (preferably carbon nanotubes with an aspect ratio of 10⁴ or more), a polymer, an ionic liquid, and a solvent. Alternatively, for some kinds of polymers and ionic liquids, a dispersion liquid may also be prepared by mixing carbon nanotubes, a polymer, and a hydrophobic solvent to thereby obtain a gel-like dispersion, then adding an ionic liquid and a hydrophilic solvent thereto, and further mixing the same.

The structure of the electroconductive film of the present invention is, for example, as shown in the SEM micrograph of FIG. 13. Because there is considered to be no unevenness on the surface of carbon nanotubes, it can be understood from the image of FIG. 13 that the thin film has a structure wherein a gel of polymer/ionic liquid surrounds the carbon nanotubes. Deformation of an actuator element upon voltage application is attributed to a mechanism whereby ions move within such a polymer gel surrounding the nanotubes, and electric double layers are thereby formed at the carbon nanotube-polymer gel interfaces. Accordingly, it can be understood that the deformability of the electroconductive film improves with an increasing amount of polymer gel in contact with the electrode material. Improvement of the dispersibility of the carbon nanotubes and resulting enlargement of the surface area is effective in increasing the amount of polymer gel in contact with the electrode. Improvement of the dispersibility of the nanotube/polymer complexes is also advantageous for improving the electrical conductivity of an electrode layer. Ideally, the electrode has a structure in which complexes are densely packed, wherein carbon nanotubes are completely dispersed and a suitable amount of ionic liquid gel surrounds each nanotube. In FIG. 13, the diameter of each nanotube/polymer complex is suitable, and the complexes are densely packed.

The dispersibility of the nanotube/polymer complexes can be determined from an analysis of the electroconductive film using suitable imaging software, which obtains the mean width (nm) of the nanotube/polymer complexes, by calculating the projected areas and lengths of polymer-complexed carbon nanotubes, and applying the formula: area/length=mean width (nm). The mean width is usually 75 nm or less, preferably 5 to 50 nm, and more preferably 10 to 35 nm.

One example of an actuator element produced according to the present invention has a three-layer structure (FIG. 1A) wherein an ion-conductive layer 1 is sandwiched between electroconductive films (electroconductive film) 2 each comprising carbon nanotubes, an ionic liquid, and a polymer. Alternatively, to increase the surface conductivity of the electrode, the actuator element may have a five-layer structure (FIG. 1B) wherein electroconductive layers 3, 3 are formed exterior to the electroconductive layers 2, 2.

Each electroconductive film layer comprises carbon nanotubes, an ionic liquid, and a polymer. It is possible to obtain a uniform dispersion by preparing a carbon nanotube gel from cabon nanotubes and an ionic liquid, and adding and mixing a polymer to the prepared gel for the purpose of the maintenance of mechanical strength. A uniform dispersion may also be obtained by further mixing a solvent thereto. The order of ingredient addition is not limited.

In order to form an electroconductive film layer on the surface of an ion-conductive layer and thereby obtain an actuator element, the procedure may be, for example, such that a dispersion liquid (for electroconductive film layer formation) comprising carbon nanotubes, an ionic liquid, a polymer and a mixed solvent, and a solution (for ion-conductive layer formation) comprising an ionic liquid, a polymer and a mixed solvent are successively made into a film by casting, and then dried while evaporating solvent.

The thicknesses of ion-conductive layer 1 and electroconductive film layer 2 are both preferably 10 to 500 μm, and more preferably 50 to 200 μm. Each layer may be formed by spin coating, printing, spraying, or the like. Further, extrusion, ejection, or the like can also be employed.

The thickness of electroconductive layer 3 is preferably 10 to 50 nm.

Using an actuator element thus obtained, when a direct-current voltage of 0.5 to 3 V is applied between the electrodes (electrodes connected to the electroconductive film layer), a displacement of about 0.5 to about 1 times the element length can be obtained within a few seconds. Such an actuator element can operate flexibly in air or a vacuum.

The working principle of such an actuator element is such that, as FIG. 2 shows, when a potential difference is applied between electroconductive film layers 2 that have been formed on the surface of an ion-conductive layer 1 in a mutually insulated state, electric double layers are formed at the interfaces between the carbon nanotube phase and the ionic liquid phase in each electroconductive film layer 2, and, due to the thereby generated interfacial stress, the electroconductive film layers 2 then expand or contract. Reasons that the actuator element bends toward the anode side, as illustrated in FIG. 2, are thought to be that the carbon nanotubes therein expand more greatly at the cathode side due to quantum chemical effects, and also that, because the ionic radius of the cation 4 in a conventionally used ionic liquid is the greater, the cathode side expands more due to this steric effect. In FIG. 2, 4 indicates a cation of the ionic liquid and 5 indicates an anion of the ionic liquid.

In an actuator element obtained by the above-mentioned method, because the effective interfacial area between the carbon nanotubes and the ionic liquid is extremely large, the impedance in the interface electric double layer becomes low. Accordingly, the electrically stimulated expansion/contraction effect of the carbon nanotubes can be effectively used. Further, from the mechanical point of view, because the junction adhesion at the interface is excellent, the durability of the element is great. As a result, an element that is highly responsive and exhibits large displacement both in air and a vacuum, and having excellent durability, can be obtained. In addition, such an element has a simple structure and is thus easy to downsize, thereby enabling operation at low electrical power levels.

The actuator element of the present invention operates with high durability in air and a vacuum. Further, it operates flexibly at low voltages. Such an actuator element accordingly is suitable for robots that come into contact with humans (for example, personal robots such as home robots, pet robots, and amusement robots) for which safety is required; robots that work in special environments, such as rescue robots as well as robots for use in space or in vaccum chambers; robots for medical use or social welfare, such as operation devices and muscle suits; and micro machines.

In particular, in material production under vacuum or super clean environments, to obtain highly purified products, there is an increasing demand for actuators for transportation and positioning of specimens, etc. The actuator of the present invention employing a non-evaporating ionic liquid does not cause any contamination, and can be effectively used in a vacuum environment as a processing actuator.

It is necessary that at least two electroconductive film layers be formed on the surface(s) of the ion-conductive layer. As shown in FIG. 3, larger numbers of electroconductive film layers 2 may also be positioned on the surfaces of a planar ion-conductive layer 1, to thereby enable complicated motion. Such an element enables transportation by peristaltic movement, a micromanipulator, and the like. The shape of the actuator element provided by the invention is not limited to planar, and an actuator with any configuration can easily be manufactured. For example, the element shown in FIG. 4 is obtained by forming four electroconductive film layers 2 on the periphery of a rod-shaped ion-conductive layer 1 having a diameter of about 1 mm. This element enables an actuator that can be inserted into a canaliculus.

The present invention is described below in more detail with reference to Examples and Comparative Examples.

The ionic liquids (ILs) used in the Examples and the Comparative Examples are 1-ethyl-3-methylimidazolium tetrafluoroborate (EMIBF₄), 1-butyl-3-methylimidazolium tetrafluoroborate (BMIBF₄), a quaternary ammonium cation-tetrafluoroborate salt (a product of Koei Chemical Co., Ltd.: A-3), a quaternary ammonium cation-(trifluoromethanesulfonyl)imide[(CF₃SO₂)₂N⁻] salt (a product of Koei Chemical Co., Ltd.: A-4). The cation of A-3 and A-4 is [N(CH₃)(CH₃)(C₂H₅)(C₂H₄OC₂H₄OCH₃)]⁺.

As carbon nanotubes, high-purity single-walled nanotubes (a product of Carbon Nanotechnologies Inc.; tradename “HiPco”) (hereinafter sometimes referred to as SWNTs) are used in the Examples and the Comparative Examples.

As carbon nanotubes with an aspect ratio of 10⁴ or more (6×10⁵ on average), single-walled carbon nanotubes having an average length of about 600 μm (LSWNTs), manufactured by National Institute of Advanced Industrial Science and Technology, Research Center for Advanced Carbon Materials, are used in the Examples and the Comparative Examples.

The polymer used in the Examples and the Comparative Examples is a polyvinylidene fluoride-hexafluoropropylene copolymer [PVDF(HFP)] represented by the following formula:

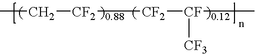

The hydrophobic solvent used in the Examples and the Comparative Examples is 4-methylpentan-2-one (hereinafter sometimes referred to as MP), and the hydrophilic solvent is propylene carbonate (hereinafter sometimes referred to as PC).

### PREPARATION EXAMPLE 1

[Preparation of a dispersion Liquid for Electroconductive Film Layer Formation]

Carbon nanotubes (SWNTs) and an ionic liquid (IL) are mixed, kneaded using a mortar, and thereby gelled (an SWNT gel). The SWNT gel is then dispersed, together with a polymer [powdered PVDF(HFP)], in only hydrophobic solvent (MP)when the IL is hydrophobic (BMIBF₄ in the Comparative Examples), or instead in a mixed solvent of a hydrophobic solvent (MP) and a hydrophilic solvent (PC) when the IL is hydrophilic (EMIBF₄ or A-3 in the Examples). A dispersion liquid for electroconductive film layer formation is thereby prepared.

When the IL is hydrophilic, use of only hydrophobic solvent may result in the hydrophilic IL contained in the SWNT gel and the solvent separating into two layers (visually observable). By using a mixed solvent of a hydrophobic solvent and a hydrophilic solvent, the hydrophilic SWNT gel and the polymer can be uniformly dispersed therein.

[Preparation of a solution for Ion-Conductive Layer Formation]

An ionic liquid (IL) and a polymer [powdered PVDF (HFP)] are dissolved in a solvent in the same manner as in the above-described preparation of a dispersion liquid for electroconductive film layer formation. A solution for ion-conductive layer formation is thereby prepared.

[Production of an Actuator Element]

An electroconductive film layer, an ion-conductive layer, and another electroconductive film layer are successively formed by casting. Drying is conducted at room temperature for a day and night to remove solvent, and vacuum drying is then performed. An actuator element is thereby obtained.

[Evaluation of an Actuator Element]

The deformation responsiveness of each produced actuator element was evaluated using an apparatus as shown in FIG. 5. The actuator element was cut into a rectangular shape with a width of 1 mm and a length of 15 mm, and, as shown in FIG. 5, it was held 3 mm from the end in a holder equipped with electrodes, and voltage was applied thereto in air. Displacement at a point 10 mm from the fixed end was measured using a laser displacement meter.

### EXAMPLE 1

(1) Preparation of an SWNT Gel of Single-Walled Carbon Nanotubes (SWNTs) and an Ionic Liquid (EMIBF₄):

SWNTs (174 mg) and EMIBF₄ (780 mg) were kneaded and the ionic liquid and carbon nanotubes were thereby gelled. An SWNT gel containing 18 wt % of SWNTs was thus obtained.

(2) Production of a Three-Layer Actuator Element wherein a PVDF (HFP) Gel of an Ionic Liquid (EMIBF₄) is Sandwiched between SWNT Gels:

The SWNT gel (39 mg) prepared in (1) above and a polymer [powdered PVDF (HFP)] (90 mg) were dispersed in a mixed solvent (2 ml) of MP and PC (weight ratio: PC/MP=1.4), to thereby prepare a dispersion liquid for electroconductive film layer formation for forming a first layer (electroconductive film layer) and a third layer (electroconductive film layer). EMIBF₄ (102 mg) and PVDF (HFP) (113 mg) were dissolved in a mixed solvent (1.5 ml) of MP and PC of the above weight ratio, to thereby prepare a solution for ion-conductive layer formation for forming a second layer (ion-conductive layer) to go between the first and third layers. An actuator element was produced as follows. First, a dispersion liquid for electroconductive film layer formation was poured onto a substrate, leveled using a spacer as a guide, and dried for a few minutes. Another spacer was arranged thereover, and a solution for ion-conductive layer formation was poured over the electroconductive film first layer, leveled, and then dried. A further spacer was arranged thereover, and a dispersion liquid for electroconductive film layer formation was poured over the ion-conductive second layer, left to dry for a day and night, and then vacuum dried. A film-like three-layer actuator element consisting of an electroconductive film layer-ion conductive layer-electroconductive film layer structure was thereby obtained.

### COMPARATIVE EXAMPLE 1

(1) Production of a Three-Layer Actuator Element wherein a PVDF (HFP) Gel of a Hydrophobic Ionic Liquid (BMIBF₄) is Sandwiched between SWNT Gels:

A dispersion liquid for electroconductive film layer formation for forming a first layer (electroconductive film layer) and a third layer (electroconductive film layer) was prepared by dispersing an SWNT gel (SWNTs (63 mg) +BMIBF₄ (245 mg)) (160 mg) prepared in the same manner as in Example 1 (1) and a polymer [PVDF (HFP)] (80 mg) in MP (1.5 ml) at room temperature. A solution for ion-conductive layer formation for forming a second layer (ion-conductive layer) to go between the first and third layers was prepared by dissolving BMIBF₄ (163 mg) and PVDF (HFP) (82 mg) in MP (0.6 ml). Using the prepared dispersion liquid for electroconductive film layer formation and solution for ion-conductive layer formation, a film-like three-layer actuator element consisting of an electroconductive film layer-ion conductive layer-electroconductive film layer structure was produced in the same manner as in Example 1 (2).

The actuator elements obtained in Example 1 and Comparative Example 1 were evaluated for their responsiveness to voltage by the above-described actuator element evaluation method. The results are shown in FIGS. 6, 7, and 8.

FIG. 6 shows displacement response obtained when square waves of 0.1 Hz and ±2.5 V were applied to an actuator element produced using EMIBF₄ (Example 1) and an actuator element produced using BMIBF₄ (Comparative Example 1). FIG. 7 shows displacement response obtained when square waves of 1 Hz and ±3 V were applied to an actuator element produced using EMIBF₄ (Example 1) and an actuator element produced using BMIBF₄ (Comparative Example 1). FIG. 8 shows degrees of displacement obtained when square waves of a frequency of 0.1 Hz and voltages from ±0.5 to 3.0 V were applied to an actuator element produced using EMIBF₄ (Example 1) and an actuator element produced using BMIBF₄ (Comparative Example 1).

It can be understood from FIGS. 6, 7, and 8 that an actuator element produced using EMIBF₄ (Example 1) is superior to an actuator element produced using BMIBF₄ (Comparative Example 1) in terms of response speed and responsiveness (displacement degree).

### EXAMPLE 2

Actuator elements were produced using EMIBF₄ as an ionic liquid, while changing the relative proportion (weight ratio) of EMIBF₄ to polymer [PVDF (HFP)] in a solution for ion-conductive layer formation as follows: EMIBF₄:polymer(poly) =1:3, 1:2, 1:1, 2:1, 3:1.

Other components and the production method were the same as in Example 1.

The voltage-responsiveness of the actuator elements thus obtained was evaluated by the above-described actuator element evaluation method. The results are shown in FIG. 9. FIG. 9 shows degrees of displacement obtained when square waves of a frequency of 0.1 Hz and voltages of ±0.5 to 3.0 V were applied to actuator elements obtained at various EMIBF₄:polymer(poly) ratios.

As is clear from FIG. 9, an actuator element wherein the relative proportion of EMIBF₄ to polymer [PVDF (HFP)] in a solution for ion-conductive layer formation was EMIBF₄:poly =1:1 resulted in the greatest responsiveness (displacement degree). Ionic conductivity increases with an increasing ratio of ionic liquid to polymer, whereas responsiveness peaks at EMIBF₄:poly =1:1. This is because an ionic liquid in a greater amount causes problems such as, for example, formation of bubbles of ionic liquid in an ion-conductive layer (electrolyte gel), which may obstruct ion migration at the interface between an electroconductive film layer and the ion-conductive layer. Among uniform electrolyte gels, those wherein EMIBF₄:poly is about 1:1 exhibit the best ionic conductivity.

### EXAMPLE 3

Actuator elements were produced, while changing the composition (PC/MP weight ratio) of the mixed solvent used in the preparation of the solution for ion-conductive layer formation as follows:
PC/MP=0.3(□), 1.4(Δ), PC only (∘).

The relative proportion of EMIBF₄ to polymer [PVDF (HFP)] in the solution for ion conductive layer formation was EMIBF₄:poly=1:1, and other components and the production method were the same as in Example 1.

The voltage-responsiveness of the actuator element thus obtained was evaluated by the above-described actuator element evaluation method. The results are shown in FIG. 10. FIG. 10 shows degrees of displacement obtained when square waves of a frequency of 0.1 Hz and voltages of ±0.5 to 3.0 V were applied to the actuator elements obtained at various PC/MP weight ratios.

With respect to each obtained ion-conductive layer (electrolyte gel), the ionic conductivity of was measured by an alternating current impedance method. With respect to each obtained actuator element, the Young's modulus of was measured by a tension test. The results are shown in Table 1 below.

TABLE 1

| | | | |
|---|---|---|---|
| PC/MP weight ratio in | 0.3 | 1.4 | PC only |
| mixed solvent | | | |
| Ionic conductivity of | 9.80 × 10⁻⁴ | 6.20 × 10⁻⁴ | 1.30 × 10⁻⁴ |
| electrolyte gel [S/cm] | | | |
| Young's modulus of | 20.5 | 15.8 | 58.9 |
| actuator element [MPa] | | | |

Table 1 indicates that, among the mixed solvents used in the preparation of a solution for ion-conductive layer formation, the mixed solvent with PC/MP=1.4 led to the smallest Young's modulus of the obtained actuator element. From this fact together with the data shown in FIG. 10 indicating that the responsiveness (displacement degree) of an actuator element obtained using the mixed solvent having a PC/MP ratio of 1.4 was the greatest, it can be understood that a Young's modulus of an actuator element effects the displacement, and that the PC/MP ratio of 1.4, which gives the smallest Young's modulus and the largest displacement, is the most suitable mixed solvent mixing ratio.

### EXAMPLE 4

Using a quaternary ammonium cation-tetrafluoroborate salt (a product of Koei Chemical Co., Ltd.: A-3) as an ionic liquid, an actuator element was produced as follows.

An SWNT gel (104 mg) prepared from SWNTs (230 mg) and A-3 (900 mg) in the same manner as in Example 1(1) and a polymer [powdered PVDF (HFP)] (47 mg) were dispersed in a mixed solvent (2 ml) of MP and PC (weight ratio: PC/MP=1.4), to thereby prepare a dispersion liquid for electroconductive film layer formation. A-3 (203 mg) and PVDF (HFP) (97 mg) were dissolved in a mixed solvent (1.5 ml) of MP and PC of the same weight ratio, to thereby prepare a solution for ion conductive layer formation. Using the thereby prepared dispersion liquid for electroconductive film layer formation and solution for ion conductive layer formation, a film-like three-layer actuator element consisting of an electroconductive film layer-ion conductive layer-electroconductive film layer structure was produced in the same manner as in Example 1(2).

The actuator element thus obtained was evaluated for its responsiveness to voltage by the above-described actuator element evaluation method, and as a result, excellent displacement responsiveness to voltage was found.

### EXAMPLE 5

(1) Preparation of a Dispersion Liquid for Electroconductive Film Production Comprising a Polymer Gel Containing an Ionic Liquid and Single-Walled Carbon Nanotubes (LSWNTs) having a mean Length of 600 μm

4-Methylpentan-2-one (MP) (1.0 ml) was added to LSWNTs (5.5 mg) and a polyvinylidene fluoride-hexafluoropropylene copolymer (PVDF (HFP)) (13.5 mg), and stirred at room temperature. After stirring the mixed solution for 6 to 10 hours, 1.0 ml of MP was added thereto, and stirring was continued at room temperature. Stirring was further continued at room temperature for two days, so that the solution was stirred for three days in total. Propylene carbonate (PC) (62 mg) and 1-ethyl-3-methylimidazolium tetrafluoroborate (EMIBF₄) (26.4 mg) were added to the highly viscous solution thus obtained, and further stirred at room temperature for three days. A dispersion liquid for electroconductive film production was thereby obtained.

(2) Preparation of a Separator Solution

PVDF (HFP) (200.3 mg) was dispersed in a mixed solution of MP (6.0 ml)/PC (0.6 ml).

(3) Production of an Actuator Element

The dispersion liquids obtained in above (1) and (2) were heated and stirred in sand baths at 75° C. for 5 to 6 hours, and then poured into a mold in the order of (1)→(2)→(1) to thereby obtain a three-layer cast film. The obtained cast film was dried at room temperature for two days, and then vacuum dried at 45° C. to thereby obtain a film-like actuator element.

(4) Actuator Properties

The actuator element obtained in (3) was evaluated by the above-described actuator element evaluation method. Some of the results are shown in FIG. 11.

(5) Dependence of displacement on voltage applied to the actuator element obtained in (3) is shown in Table 2 below (Frequency: 0.1 Hz).

TABLE 2

| | | | | |
|---|---|---|---|---|
| Applied voltage (V) | 1.0 | 2.0 | 2.5 | 3.0 |
| Observed displacement (mm) | 1.5 | 5.4 | 6.4 | 6.8 |

(7) Dependence of displacement on frequency of the applied voltage of the same sample was measured. It was accordingly revealed that displacement response is obtained up to 50 Hz. Displacement at this frequency was 0.018 mm (50 Hz) The present inventors have verified that displacement response is possible up to 100 to 120 Hz, although data therefor is not shown in this specification.

### EXAMPLE 6

(1) In the same manner as in Example 5, using a twice as much EMIBF₄, a dispersion liquid for electroconductive film production was prepared and a three-layer actuator element was then obtained. Time profiles in yielded current and displacement in this case are shown in FIG. 12.

(2) Dependence of displacement on voltage applied to the actuator element obtained in Example 6(1) is shown in Table 3 below (Frequency: 0.1 Hz).

TABLE 3

| | | | | |
|---|---|---|---|---|
| Applied voltage (V) | 1.0 | 2.0 | 2.5 | 3.0 |
| Observed displacement (mm) | 1.2 | 2.9 | 7.9 | 8.5 |

In the following Examples 7 to 9, EMIBF₄ is referred to as “IL”.

### EXAMPLE 7

A dispersion liquid comprising SWNTs, IL, and polymer in a weight ratio of SWNTs:IL:polymer=2:8:5, and wherein about 10 ml of MP/PC mixed solvent (MP:PC=15:1) was used per 10 mg of SWNTs, was ultrasonically dispersed for 1 hour and further diluted with tens of times the amount of MP, to thereby obtain a dispersion liquid. The obtained dispersion liquid was cast over a p-type silicon substrate, and dried for a day and night. Os was vapor-deposited thereon for 10 seconds, and a sample for SEM was thereby obtained.

### EXAMPLE 8

A carbon nanotube gel (CNT gel) obtained by mixing and kneading at a weight ratio of SWNTs:IL=1:4 using an onyx mortar was mixed at a weight ratio of CNT gel:polymer=2:1. Using about 10 ml of MP/PC mixed solvent (MP:PC=15:1) per 150 mg of CNT gel, the above CNT gel and polymer were dispersed in MP, and this dispersion liquid was stirred for 30 minutes. The dispersion liquid was diluted with tens of times the amount of MP, cast over a p-type silicon substrate, and dried for a day and night. Os was vapor-deposited thereon for 10 seconds, and a sample for SEM was thereby obtained.

### EXAMPLE 9

A dispersion liquid comprising SWNTs, IL, and polymer in a weight ratio of SWNTs:IL:polymer=2:8:5, and wherein about 10 ml of MP/PC mixed solvent (MP:PC=8:5) was used per 10 mg of SWNTs, was ultrasonically dispersed for 1 hour and further diluted with tens of times the amount of MP, to thereby obtain a dispersion liquid. The obtained dispersion liquid was cast over a p-type silicon substrate, and dried for a day and night. Os was vapor-deposited thereon for 10 seconds, and a sample for SEM was thereby obtained.

### EXAMPLE 10

<Production of an Element>

Each of the dispersion liquids for electrode layer production diluted to tens of times the amount with MP obtained in Examples 7 to 9 was cast over a p-type silicon substrate, and dried in air at room temperature. A solution for electrolyte comprising a polymer dissolved in MP (10 to 12 ml of MP per 100 mg of polymer) was cast thereover, and dried in air at room temperature. Further dispersion liquid for electrode layer production was then cast thereover, and dried in air at room temperature. A film with a bimorph structure having a thickness of about 0.1 mm was thereby obtained. Solvent was completely vaporized from obtained films using a vacuum drier, and actuator elements were thereby produced.

<FE-SEM Observation Method>

The three Os-coated silicon substrates obtained in the above examples were observed in vacuum using a scanning electron microscope, FE-SEM (Hitachi S-5000). The acceleration voltage was set at 15 kV. Micrographs thus obtained are shown in FIGS. 13, 14, and 15.

<Measurement of Displacement>

Rectangular specimens of 1 mm×15 mm were cut out from the film-like actuators obtained above, and gold electrodes were mounted 3 mm from the upper ends. Square wave voltages were applied thereto, and the degree of displacement (bending displacement) at the point 10 mm from each electrode's end was measured using a laser displacement meter. The results are shown in FIG. 16.

In FIG. 16, ▪ indicates, for reference, values with respect to an actuator element produced by the same methods as in the above Example 8 and <Production of an element>, except that the MP/PC ratio in the mixed solvent was MP:PC=7:1.

<FE-SEM Image Analysis>

The image files of FIGS. 13 to 15 were converted into bitmap format, and, using imaging software (Adobe Photoshop™ 5.5 For Windows), noise was removed, and the level and contrast were corrected. Further, using “A-zou kun” software (Ver 2.20 For Windows; a product of Asahi Kasei Engineering Co., Ltd.), the scale was set by a microscopic image scale bar, and, using a particle extraction operation, the target object (i.e., a string-like carbon nanotube complex) was converted into an extracted binary image. The image of the nanotube was suitably cut into a rectangular shape. The projected areas and lengths were obtained therefrom, and the mean width (nm) was calculated from (area)/(length). The extracted binary image was obtained, in order to extract an object in the image, by setting a certain brightness as a threshold, converting the image into a two-color image wherein portions brighter than the threshold are expressed in white and portions darker than the threshold are expressed in black, and thereby separating and extracting the object from the background (substrate surface).

The results are shown in Table 4 below.

TABLE 4

| Sample | Mean width (nm) |
|---|---|
| Example 7 (FIG. 13) | 25.3 |
| Example 8 (FIG. 14) | 49.4 |
| Example 9 (FIG. 15) | 72.7 |

It appears that the thinner a carbon nanotubes/polymer/IL structure is, the higher is its dispersibility.

A correlation exists between these dispersibility measurement results and the results of bending response displacement measurement, and it is thus revealed that the higher the dispersibility is, the greater is the responsiveness.

### BRIEF DESCRIPTION OF THE DRAWINGS

FIG. 1: FIG. 1(A) shows a schematic diagram of one example of the actuator element (three-layer structure) of the present invention, and FIG. 1(B) shows a schematic diagram of another example of the actuator element (five-layer structure) of the present invention.

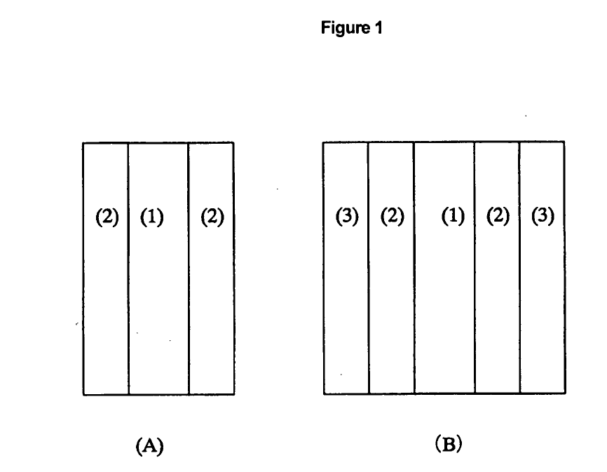

FIG. 2: FIG. 2 shows the working principle of an actuator element of the present invention.

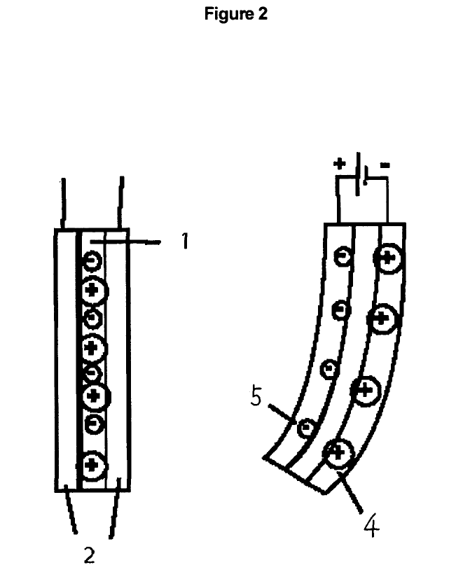

FIG. 3: FIG. 3 shows a schematic diagram of an actuator element according to another embodiment of the present invention.

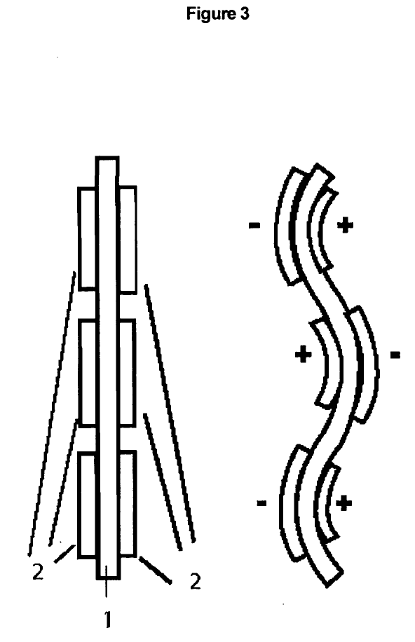

FIG. 4: FIG. 4 shows a schematic diagram of an actuator element according to still another embodiment of the present invention.

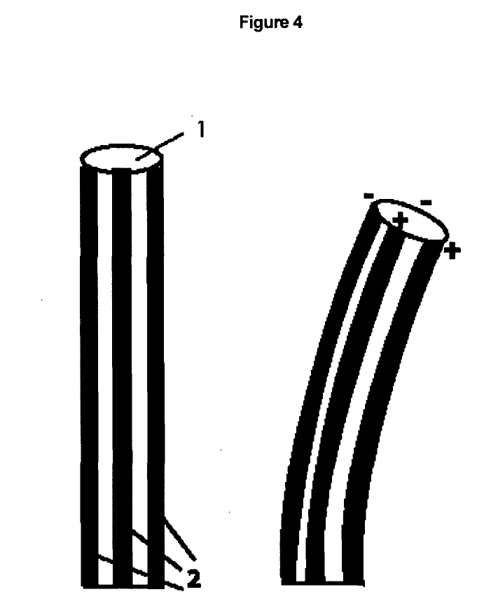

FIG. 5: FIG. 5 shows a schematic diagram of a displacement measuring device.

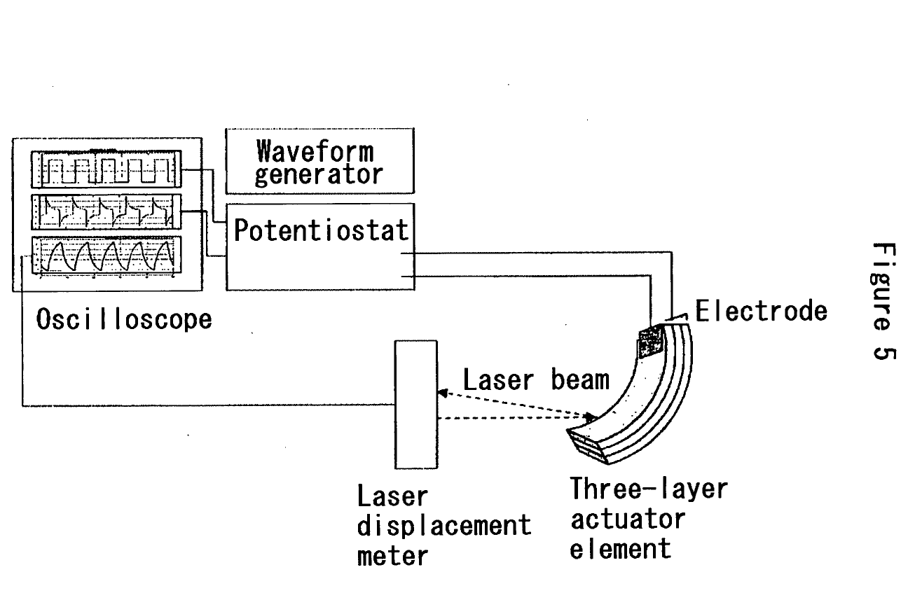

FIG. 6: FIG. 6 shows the responsiveness of the actuator elements obtained in Example 1 and Comparative Example 1.

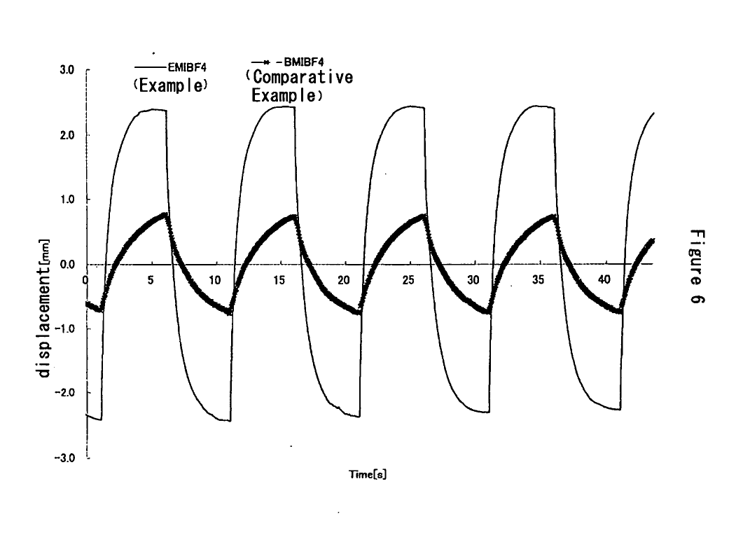

FIG. 7: FIG. 7 shows the responsiveness of the actuator elements obtained in Example 1 and Comparative Example 1.

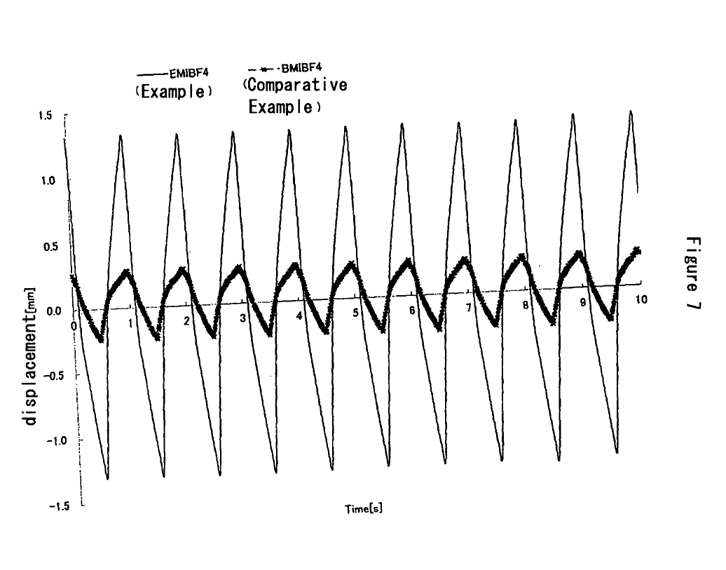

FIG. 8: FIG. 8 shows the responsiveness of the actuator elements obtained in Example 1 and Comparative Example 1. In FIG. 8,

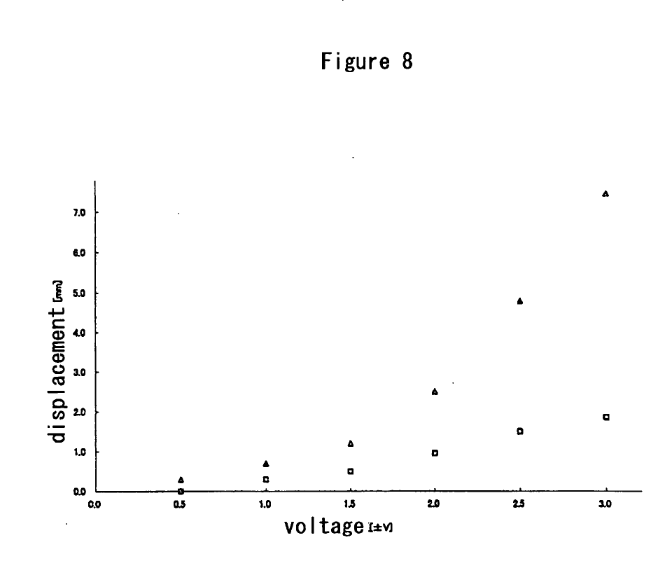

Δ: EMIBF4 (Example); and

□: BMIBF4 (Comparative Example).

FIG. 9: FIG. 9 shows the responsiveness of the actuator elements obtained in Example 2. In FIG. 9,

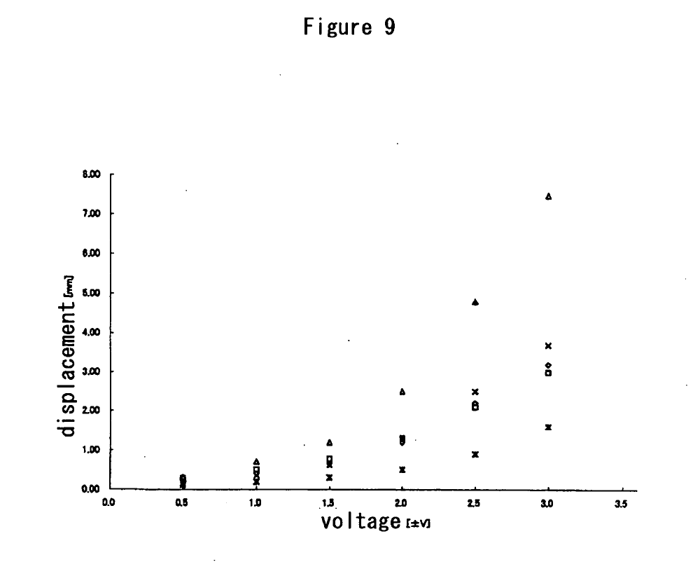

□: BMIBF4:poly=1:3;

⋄: BMIBF4:poly=1:2;

Δ: BMIBF4:poly=1:1;

x: BMIBF4:poly=2:1; and

*: BMIBF4:poly=3:1.

FIG. 10: FIG. 10 shows the responsiveness of the actuator elements obtained in Example 3. In FIG. 10,

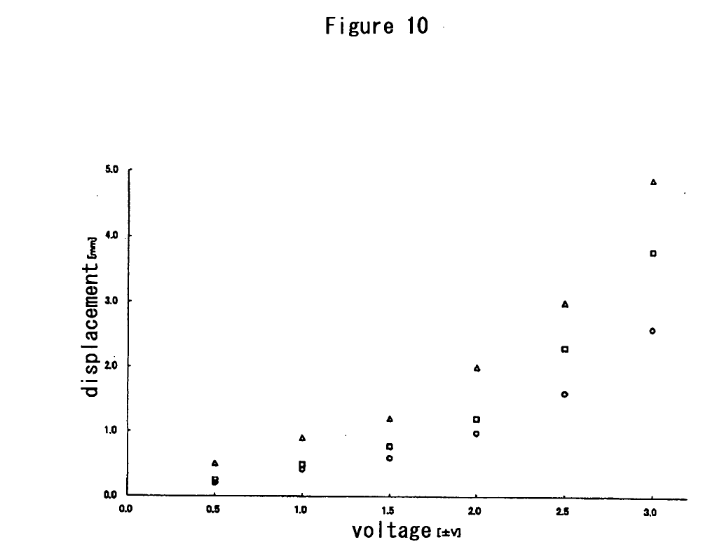

Δ: PC/MP=1.4;

□; PC/MP=0.3; and
∘: PC only.

FIG. 11 : FIG. 11 shows results of an actuator property evaluation (±3.0 V applied) (Example 5)

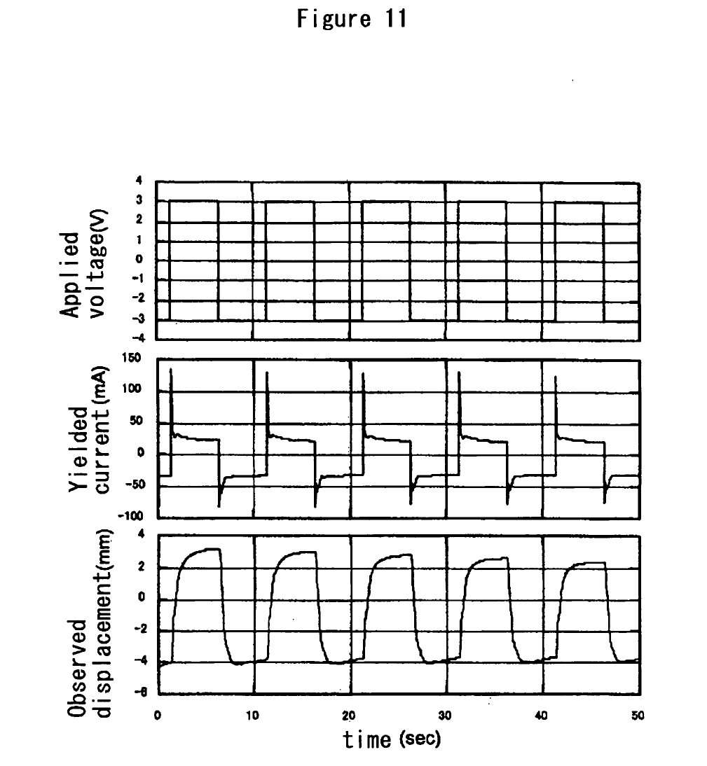

FIG. 12: FIG. 12 shows results of an actuator property evaluation (±2.5 V applied) (Example 6)

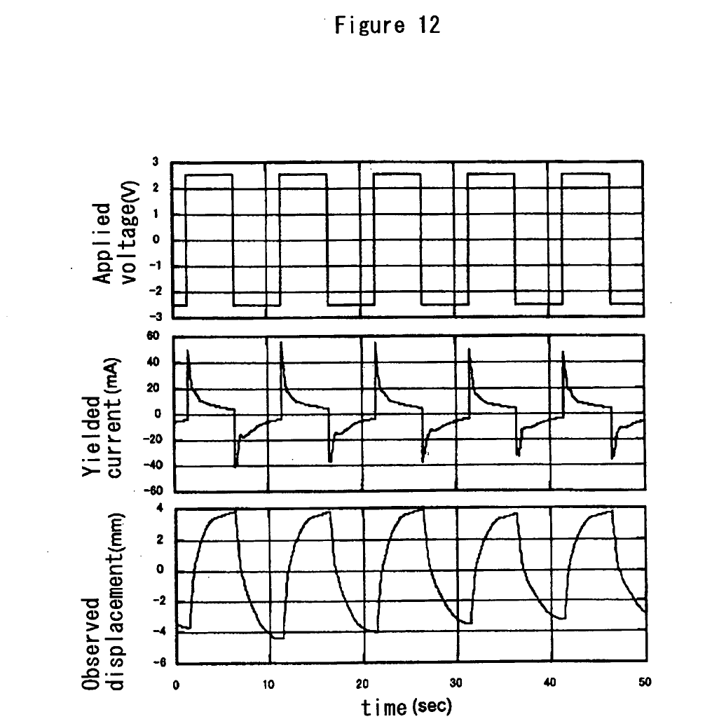

FIG. 13: FIG. 13 shows an SEM micrograph of the actuator element of Example 7.

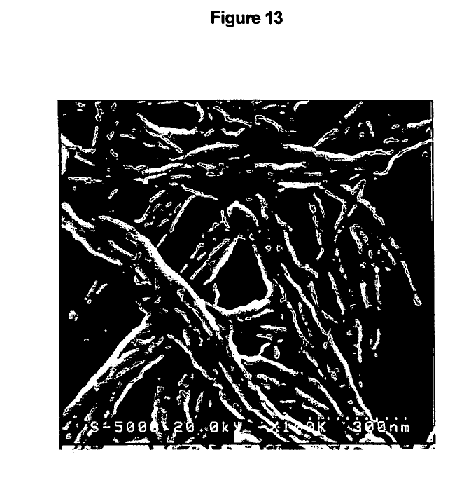

FIG. 14: FIG. 14 shows an SEM micrograph of the actuator element of Example 8.

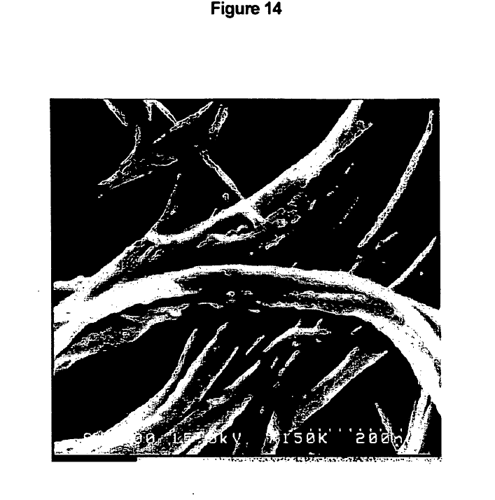

FIG. 15: FIG. 15 shows an SEM micrograph of thg actuator element of Example 9.

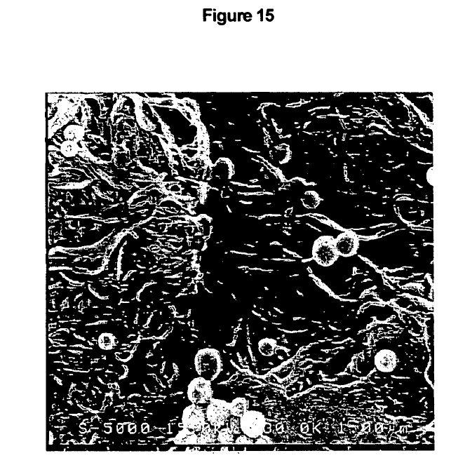

FIG. 16: FIG. 16 shows the results of the bending response displacement measurement made in Example 10. In FIG. 16,

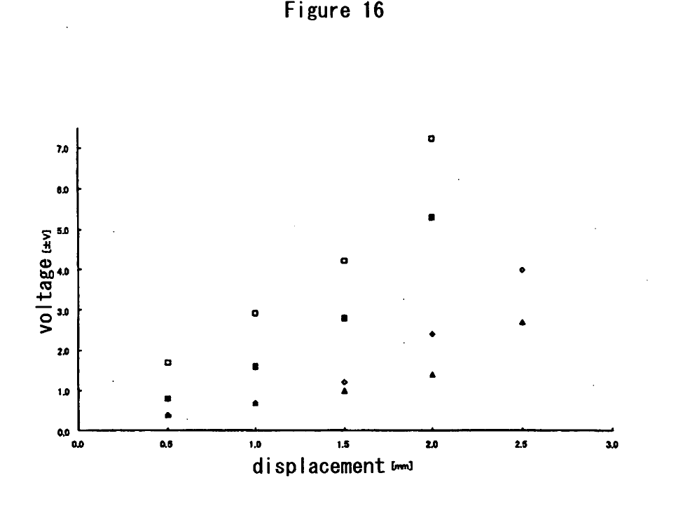

□: Example 7 (PC/MP=1/15) ultrasound;

⋄: Example 8 (PC/MP=1/15) stirring;

Δ: Example 9 (PC/MP=5/8) ultrasound; and

▪: Reference (PC:MP=1/7) stirring.

1. An electroconductive film comprising a polymer gel containing carbon nanotubes with an aspect ratio of at least 10³, an ionic liquid, and a polymer.

2. An electroconductive film comprising a polymer gel containing carbon nanotubes with a length of at least 50 μm, an ionic liquid, and a polymer.

3. An electroconductive film characterized in that the electroconductive film comprises a polymer gel containing carbon nanotubes, an ionic liquid, and a polymer, and that the carbon nanotubes and the polymer form complexes having a mean width of 50 nm or less.

4. A laminate comprising:
a layer of an electroconductive film of claim 1 any one, and an ionic conductive layer.

5. An actuator element comprising a laminate of claim 4.

6. An actuator element according to claim 5, comprising at least two of the electroconductive film layers formed as electrodes on an ion conductive layer in a mutually insulated state, the actuator element being deformable by application of a potential difference between the electroconductive film layers.

7. A method for producing an actuator element, comprising the steps of:
step 1: preparing a dispersion liquid containing carbon nanotubes, an ionic liquid, a polymer, and a solvent;
step 2: preparing a solution containing a polymer, a solvent, and optionally an ionic liquid; and
step 3: forming a laminate comprising an electroconductive film layer and an ion-conductive layer, by forming an electroconductive film layer from the dispersion liquid of step 1 and simultaneously or subsequently forming an ion-conductive layer from the solution of step 2 (the electroconductive film layer and the ion-conductive layer each being formed by coating, printing, extrusion, casting, or ejection), wherein each said solvent is a mixed solvent of a hydrophilic solvent and a hydrophobic solvent.

8. A method according to claim 7, wherein the carbon nanotubes are carbon nanotubes with an aspect ratio of at least 10³.

9. A laminate comprising:
a layer of an electroconductive film of claim 2, and
an ionic conductive layer.

10. A laminate comprising:
a layer of an electroconductive film of claim 3, and
an ionic conductive layer.

11. An actuator element comprising a laminate of claim 9.

12. An actuator element comprising a laminate of claim 10.

13. An actuator element according to claim 11, comprising at least two of the electroconductive film layers formed as electrodes on an ion conductive layer in a mutually insulated state, the actuator element being deformable by application of a potential difference between the electroconductive film layers.

14. An actuator element according to claim 12, comprising at least two of the electroconductive film layers formed as electrodes on an ion conductive layer in a mutually insulated state, the actuator element being deformable by application of a potential difference between the electroconductive film layers.
